(19) United States
(12) Patent Application Publication
(10) Pub. No.: US 2009/0231411 A1
(43) Pub. Date: Sep. 17, 2009

(54) Integrated web-based instant messaging apparatus used as a video phone

(76) Inventor: Zhihua Yan, Rowland Heights, CA (US)

Correspondence Address: Zhihua Yan, 2408 Brisa Lane, Rowland Heights, CA, 91748, US

(21) Appl. No.: 12/229,036

(22) Filed: Aug. 19, 2008

Related U.S. Application Data
(60) Provisional application No. 60/966,192, filed on Aug. 24, 2007.

(51) Int. Cl. H04N 7/14

(52) U.S. Cl. 348/14.02

(57) ABSTRACT

The present invention provides a method to perform real time audio and visual transmitting/receiving by using web-based instant messaging apparatus which is dedicated to visual telecommunication as a video phone. The device integrates all necessary hardware into one single portable size body, embeds all network communication software and preloads instant messaging carriers' application programs. The advantages of the invented apparatus are low manufacture costs, simple operational use, remote communication thru Internet, high mobility/portability, versatile video functions, and ease of use for personal or business purpose.

### BACKGROUND OF THE INVENTION

As internet infrastructure has experienced rapid development, telecommunication through network becomes more feasible and available for business and ordinary consumers. High speed internet accesses, supported by broadband or digital subscribed line (DSL) services which are shared with respective cable TV and phone lines, are already penetrating more and more residential customers. The trend may be sustained with recent development of optical application into telecommunication, which dramatically speed up data processing or flowing by using light of pulse through light circuit or fiber, instead of sending electrons over metal interconnector or wires. Examples are progresses in worldwide FTTP (Fiber To The Premise) projects and recent IBM's super fast optical chipset prototype reaching 160 Gigabites data transfer rate. Fast connectivity rate for data, voice and video through network will improve quality of audio/video communication over the Internet, therefore attract more households to subscribe the high-speed Internet access for on-line activities. Instant web messaging system for voice and video chat is one of network applications that allow audio-video bidirectional communication, which is real-time and free over Internet.

However, currently instant messaging is mainly used in live web-chat by those who have a certain level of computer and network knowledge. It is executed on sophisticated personal computers. These computers usually have a multi-purpose central processing unit (CPU) chip or chipset in hard drive, and many kinds of software loaded for other irrelevant applications. They have various input/output (I/O) devices, such as a mouse, keyboard, printer, fixed or removable data storage units, and associated media, or a large display screen. It has to use desktop or laptop computers, which are often expensive, bulky and inconvenient for the sole purpose of audio-video communication through Internet. A first time user may need to purchase and attach other accessories, such as a webcam, a microphone or a speaker. The user will also need to download software provided by a messenger carrier to establish network communication. The process to acquire and install above hardware and software are often time consuming and not success guaranteed, and require a certain level of the user's computer & network knowledge. Many potential customers who are attracted by this feature might be scared away for concerning the required installation process.

Accordingly, there exists a need in the network communication industry for an inexpensive and integrated apparatus and method, which overcomes the above-mentioned deficiencies. The apparatus of my invention provides a machine that assembles in one unit all hardware parts necessary for audio-video communication by using instant web messaging over Internet or local network. The invention also embeds inside microchips all software needed for audio-video communication over Internet. The invented apparatus may be a turnkey unit for those customers, who want to make free domestic or international video phone calls over internet but don't know how or don't want to go through detailed hardware and software installation.

### PRIOR ART

U.S. Pat. No. 5,999,207, Rodriguez et al., Method and apparatus for implementing a user interface for a videophone in a cable television network
U.S. Pat. No. 6,124,882, Voois et al., Videocommunicating apparatus and method therefor
U.S. Pat. No. 6,201,562, Lor, Internet protocol video phone adapter for high bandwidth data access
U.S. Pat. No. 6,282,272, Noonen et al., Telephone web browser arrangement and method
U.S. Pat. No. 6,493,020, Stevenson et al., Television video phone
U.S. Pat. No. 6,789,120, Lee et al., Real-time audio/video communication method for use on the internet and device therefor
U.S. Pat. No. 6,810,036, Dang et al., Caller IP address
U.S. Pat. No. 7,003,795, Allen, Webcam-based interface for initiating two-way video communication
U.S. Pat. No. 7,113,803, Dehlin, System and method for enabling instant messaging on a mobile device
U.S. Pat. No. 7,240,214, Gazzetta et al., Centrally controllable instant messaging system
U.S. Pat. No. 7,257,550, Wilson Jr. et al., Leveraging instant messaging presence to drive sales opportunities

### Other Publications

IBM announcement on OFC 2007, Mar. 26, 2007, reported 160 Gigabits optical transfer rate.

Fiber-to-the-Home (FTTH) Council, www.ftthcouncil.org.

### Advantages

Others have invented elements of hardware and software for instant web messenger over Internet, but mine is superior because it may have one or more of the following advantages:
1 it is easy and ready to use as a videophone over the Internet.
2 it doesn't require the user to install more parts or accessories for the said application.
3 it doesn't need to load software for machine operation or A/V (Audio/Video) communication.
4 it doesn't need to use a personal computer to establish network communication.
5 it reduces need on computer literacy of a user to operate the apparatus.
6 it is not vulnerable to hackers or virus during A/V communication over Internet as all programs are run using embedded software.
7 it is small in dimension and can be folded when not in use, alloying it to be movable and portable.
8 it allows free A/V communication when access to the Internet is available.
9 it allows more versatile image taking, not limited to the sender itself.
10 it may be used for live video web-chat, domestic & international videophone calls, cooperate video conferences, customer service, technical support/repairing, remote monitoring/diagnose, online ordering, online ads, and security surveillance.

### DRAWINGS—FIGS.

FIG. 1 is a perspective view of my integrated instant web messaging system.

FIG. 2 is a detailed view of keypad.

FIG. 3 is front view of LCD display with 3 viewing options.

FIG. 3A: both sender and receiver's images are shown;

FIG. 3B: only receiver's image is shown;

FIG. 3C: only sender's image is shown.

FIG. 4 is front and right-side view of LCD display with 2 webcam pointing options.

FIG. 4A: front view of image display when webcam points to sender;

FIG. 4B: right-side view when webcam points to sender;

FIG. 4C: front view of image display when webcam rotates and points to rear;

FIG. 4D: right-side view when webcam rotates and points to rear.

FIG. 5 is side view of the unit.

FIG. 5A: right-side view of the unit for volume control and audio jacks;

FIG. 5B: rear view of the unit for DC power in and network connecting jacks;

FIG. 5C: left-side view of the unit for a jack to computer USB port.

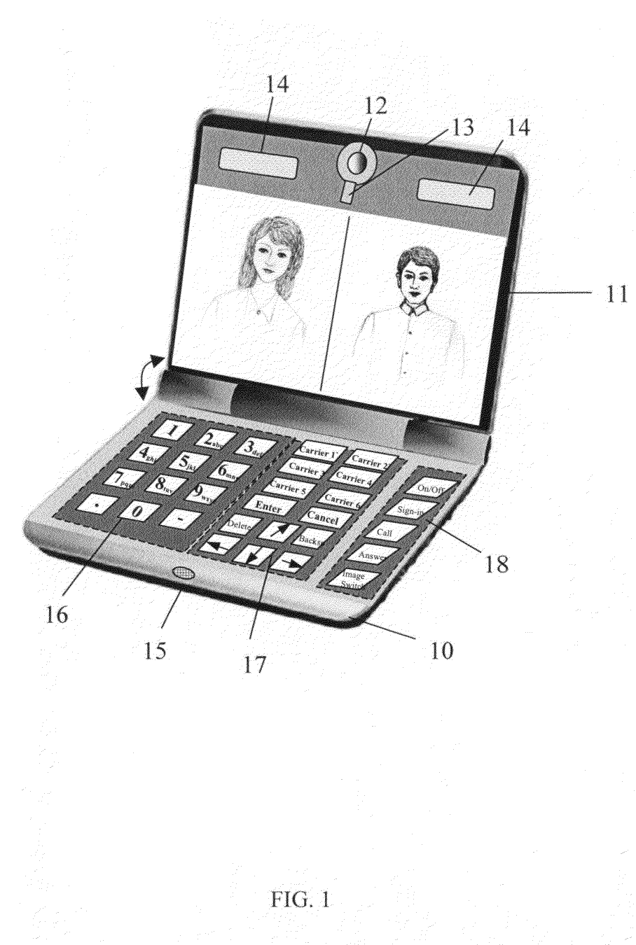

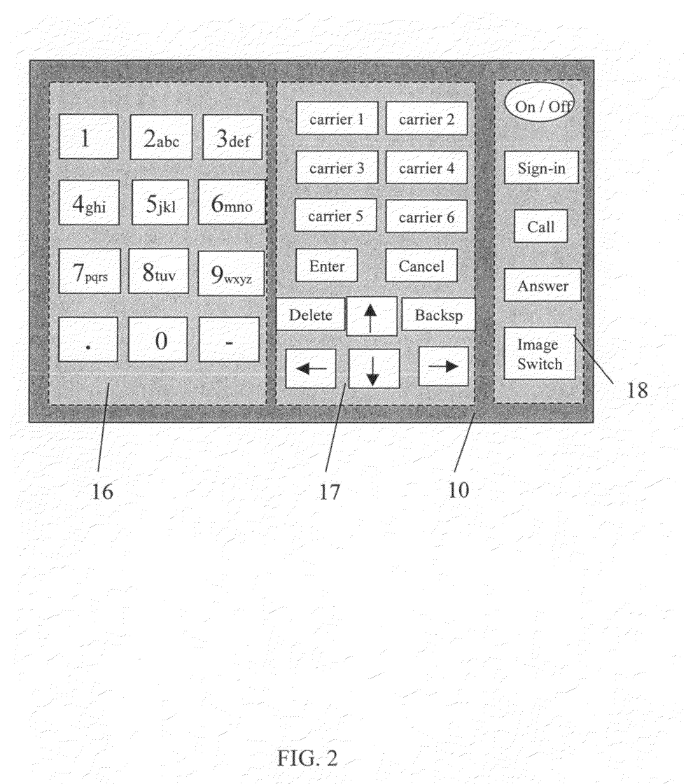

### DRAWINGS—REFERENCE NUMERALS

10 base plate.
11 LCD display plate.
12 webcam.
13 webcam adjustable rod.
14 speaker.
15 microphone.
16 keypad, numerical.
17 keypad, function.
18 keypad, operation.
19 volume control.
20 microphone in jack.
21 headphone jack.
22 DC power in jack.
23 cable modem or router jack.
24 DSL modem jack.
25 USB jack to computer.

### DESCRIPTIONS

The components of my invention are:
a rotatable and foldable frame in thickness about 1 inch, made of base plate 10 and liquid crystal display (LCD) plate 11 in dimension between 5 to 10 inch.
microchip or micro-chipsets inside base plate 10, having all embedded software necessary for operation of said application.
keypads on base plate 10 for entering/storing network ID to be called, selecting messenger carrier and controlling operation.
audio/video devices integrated to base plate 10 or display plate 11: webcam 12 and its rotatable rod 13, speaker 14, and microphone 15.
jacks for DC power in, microphone, headphone, and DSL and cable modem in.

In my invention, all hardware components are integrated and assembled into one foldable unit which has all software embedded for network communication and audio/video signal processing. The unit may be ready for use when connected to Internet through cable modem, a router or DSL phone line modem. A user needs to turn on power and sign-in to desired messaging carrier in keypad 18, to enter first portion of receiving network address (e.g., xxxxx if the address is xxxxx@yahoo.com) through numerical keypad 16, to select instant messaging carrier on functional keypad 17, and to initiate dialing by pressing the Call button in keypad 18. The party to be called will be alerted the incoming call. Two-way audio/video communication via network will be established if the receiver answer the call.

An instant messaging carrier is defined here as a network service provider who has its own server and supporting software for voice and video communication. Instant messaging carriers available in my invention may be some, all or more than the examples given below: Yahoo, MSN, AOL, Skype, Paltalk, SightSpeed.

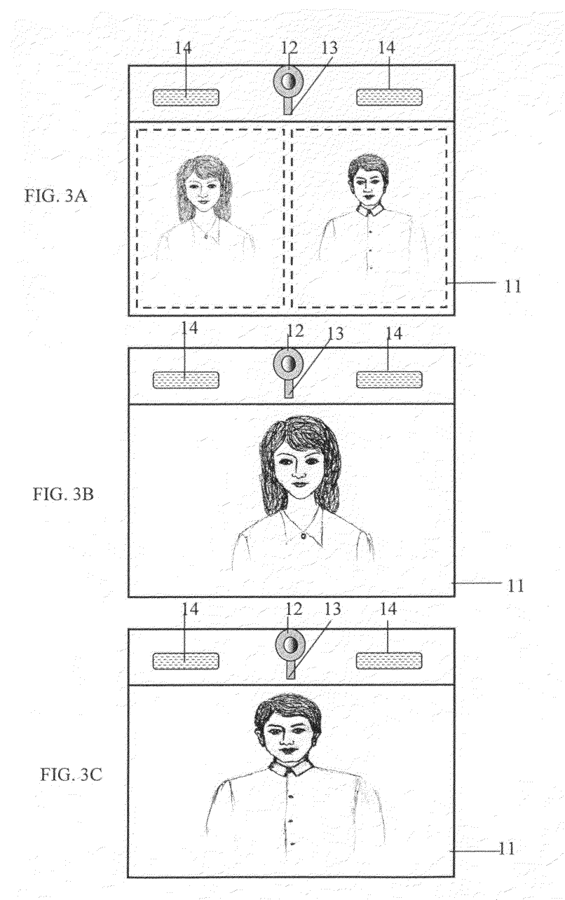

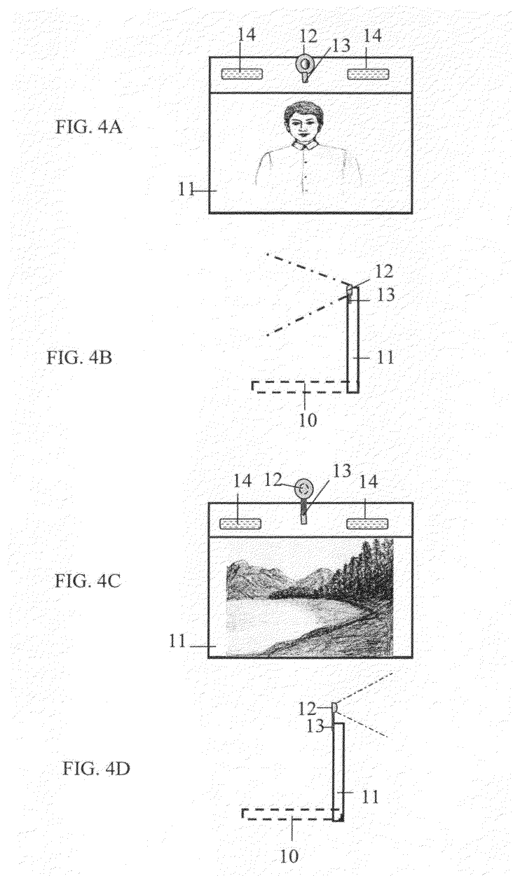

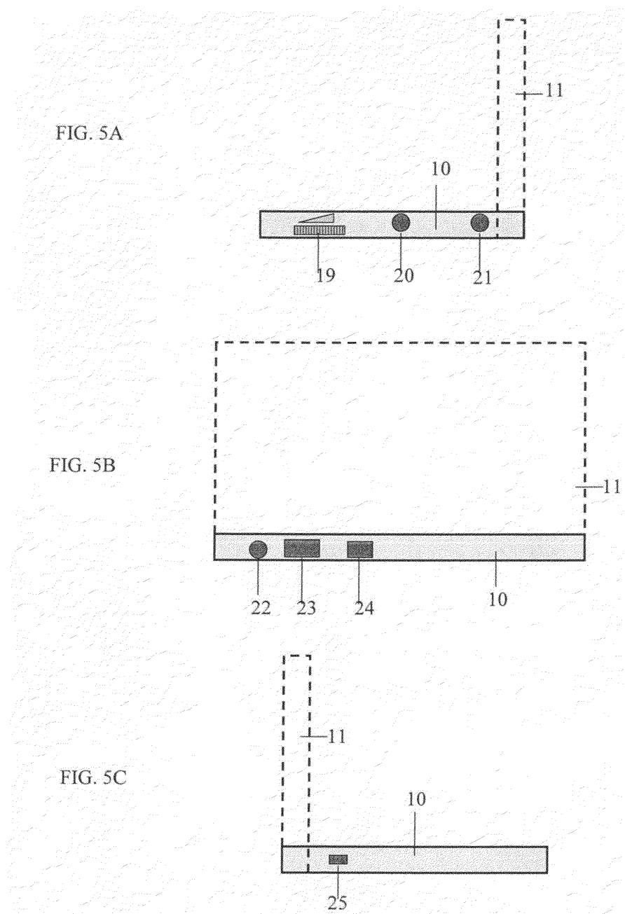

When it is powered on and connected to network, the unit of my invention may ring to alert an incoming call. A user may decide to start the audio/video communication by pressing the Answer button in keypad 18. The network address to be called may be stored, listed, withdrawn, deleted or modified in keypad 17. By pressing Image Switch button in keypad 18, a user may view images of both sender/receiver, receiver only or sender only, as shown in FIG. 3A-C. The webcam 12 can also be pulled up from webcam adjustable rod 13 mounted on LCD plate 11 and rotated 180 degree backwards, to display surrounding scenery of the sender.

### SUMMARY

My apparatus has one or more of the following benefits:
1. simplicity, low cost and ease of operation, because all hardware parts are integrated and assembled into one unit in my invention and the apparatus uses those hardware and software components that are necessary only for web voice/video messaging application.
2 less interference from virus or network hacker and no need to download extra software, because all necessary programs are embedded in microchips.
3 usage as a video phone over internet or local network.

### Alternative Embodiments

1 may change function or arrangement of one or more keys in keypad for design modification.
2 may be applied to local area network (LAN) when access is available.
3 may enable it movable and portable if battery and wireless function are added.
4 may be suitable for indoor and outdoor image taking if webcam exposure adjustment mechanism is added for brightness change.
5 may have changes in dimension, size, volume or thickness of one or more parts for similar application but different customers.
6 may add some accessories or I/O ports for communicating with computers, TV sets or other devices.

1. A method of integrating webcam, speaker and microphone into a single apparatus having capability of voice and video communication through an internet web-based instant messaging provider.

2. The apparatus of video communication is small in volume, compact in size and light in weight.

3. The apparatus of video communication is movable and portable when equipped with battery and wireless function.

4. The apparatus of video communication is operational in both indoor and outdoor environments.

5. A method of mounting webcam on a rotatable and collapsible rod allowing versatile picture or video taking of the sender or object in front of sender.

6. The apparatus of video communication may be used as a video phone, or utilized in technical service, remote diagnosis, sightseeing sharing, surveillance, advertising, and teleconference.

7. The apparatus is dedicated to video communication through out the internet by embedding all necessary software to microchips and eliminating all non-related software and peripheral used in other similar devices such as a laptop computer.

8. The apparatus with embedded software is free from virus or hacker attack during operation.

9. The apparatus with embedded software is free from malfunctioning caused by operation errors, eliminating the possibility of accident deleting or change of software.

10. Use of the apparatus demands little or even no computer literacy, creating ease and simplicity of operation.

11. Use of apparatus exempts a user from software downloading, hardware selection and installation.

12. The apparatus can be used through DSL, cable broadband or FTTP internet access and still be compatible to various internet providers.

13. The apparatus can be used cordless or wireless wherever signal is available.

14. Compact design and embedded microchip decrease manufacturing cost and increase market popularity.
